(19) United States
(12) Patent Application Publication
(10) Pub. No.: US 2011/0161792 A1
(43) Pub. Date: Jun. 30, 2011

(54) PRODUCING INTERACTIVE DOCUMENTS

(76) Inventors: Edward Florence, Toronto (CA); Garvan Keeley, Toronto (CA); Josh Knauer, Mississauga (CA)

(21) Appl. No.: 12/651,099

(22) Filed: Dec. 31, 2009

(51) Int. Cl. G06F 17/00; G06F 3/048

(52) U.S. Cl. 715/205; 715/255; 715/808

(57) ABSTRACT

A method for converting a source document having graphical subject matter into an interactive document includes receiving, via a user interface, input regarding information to be tagged to objects on the source document and tagging information to objects on the source document in response to the input, thereby creating interactive effects based on the tagged information. The interactive effects can include pop-ups, external e-mail and URLs, and other interactive behavioral actions. A set of files that defines an interactive document is automatically created, wherein the interactive document incorporates the subject matter of the source document and includes the interactive effects. In another aspect, a computer readable medium containing instructions for controlling a computer system to perform a method of converting a source document having graphical subject matter into an interactive document is provided.

### BACKGROUND OF THE INVENTION

The present invention relates generally to creating interactive documents and more particularly to automatically converting documents into interactive documents in Flash format.

Adobe Flash is computer software for adding animation and interactivity to web pages and other documents outside of the Internet. The idea of producing maps in Flash format has become quite popular in recent years. The Flash format provides many interactive features that are useful or desirable for web-based map documents. One such feature is rollover or bubble pop-ups—pop-ups displaying information about a geographic feature or object that appear when the object on the map is rolled over or clicked on. Other interactive features popular with map documents include navigation controls (panning and zoom in and zoom out), layer visibility control and search capability. These interactive features can also be employed with data-rich documents other than maps, such as general drawings, CAD documents and the like.

Currently, all such interactivity is produced manually. For example, a user creates the web-based map (using any known technique). Then, the user has to “attach” the attribute data to the relevant geographic features or objects using a series of manual and tedious processes. This is done by typing in the data on an object-by-object basis. The user would also have to manually write software to produce pop-up bubbles, rollovers, navigation controls, searching capabilities, etc. This manually produced interactivity is very time consuming and labor intensive.

### SUMMARY OF THE INVENTION

One aspect of the present invention provides a method for converting a source document having graphical subject matter into an interactive document. The method includes receiving, via a user interface, input regarding information to be tagged to objects on the source document and tagging information to objects on the source document in response to the input, thereby creating interactive effects based on the tagged information. The interactive effects can include pop-ups, external e-mail and URLs, and other interactive behavioral actions. A set of files that defines an interactive document is automatically created, wherein the interactive document incorporates the subject matter of the source document and includes the interactive effects. Another aspect of the present invention provides a computer readable medium containing instructions for controlling a computer system to perform the method of converting a source document having graphical subject matter into an interactive document.

### DESCRIPTION OF THE DRAWINGS

FIG. 1 is a block diagram of a computer system for implementing a software tool for producing interactive documents.

FIG. 2 is a flow chart depicting one embodiment of a method for converting a document into an interactive document.

FIG. 3 is a screenshot of a source document used in a first example of the method for converting a document into an interactive document.

FIG. 4 is a screenshot of an editing panel used by the software tool.

FIG. 5 is a screenshot of an attribute table used by the software tool in connection with the first example of the method.

FIG. 6 is a screenshot of a layer selection panel used by the software tool in connection with the first example of the method.

FIG. 7 is a screenshot of a web tag dialog box used by the software tool in connection with the first example of the method.

FIG. 8 is a screenshot of an export dialog box used by the software tool in connection with the first example of the method.

FIG. 9 is a screenshot of a web export log used by the software tool in connection with the first example of the method.

FIG. 10 is a screenshot of the interactive document produced by the first example of the method.

FIG. 11 is a screenshot of a source document used in a second example of the method for converting a document into an interactive document.

FIG. 12 is a screenshot of the source document of FIG. 11 having objects defined thereon.

FIG. 13 is a screenshot of an attribute table used by the software tool in connection with the second example of the method.

FIG. 14 is a screenshot of a web tag dialog box used by the software tool in connection with the second example of the method.

FIG. 15 is a screenshot of an export dialog box used by the software tool in connection with the second example of the method.

FIG. 16 is a screenshot of the interactive document produced by the second example of the method, showing a pop-up.

FIG. 17 is a screenshot of the interactive document produced by the second example of the method, showing a search result.

### DETAILED DESCRIPTION OF THE INVENTION

The present invention relates generally to systems, methods, and computer program products for producing interactive documents wherein hidden (not readily visible) information or attributes may be revealed and searched. One aspect of the present invention relates to a software tool that provides the ability to easily and automatically convert an electronic document into an interactive document, such as an intelligent, data-rich document in Adobe Flash format. As used herein, the term “document” refers to any computer file (other than computer programs or system files) containing graphical subject matter (i.e., information that can be displayed in some manner). Examples of such documents include, but are not limited to, maps, diagrams, photographs, drawings, schematics and the like, as well as combinations thereof. Furthermore, a document can contain multiple data layers. A data layer is essentially a subset of the totality of data making up the document, although all of the data of a document can be contained in a single layer. Layers can be viewed as a way of organizing and managing the data. For example, a document that is a map of the United States could comprise a layer defining the outline of the country, another layer defining the state boundaries, and yet another layer defining the capital city for each state.

Although it is applicable to a wide range of documents (and is not limited to any particular type of document), the present invention is well suited for converting map documents into interactive documents. Map documents are often created with one or more geographic information system (GIS) data files. A GIS data file has two components: spatial data and attribute information. Spatial data relates to information about the location and shape of, and relations among, geographic features or objects such countries, states, cities, roads, lakes, rivers, etc. These geographic objects are often expressed as points, lines, or areas (also referred to as polygons) depending on their geometrical shapes. In other words, a city may be represented as a point, a road or a river may be represented as a line, and a state or a lake may be represented as an area. Attribute information is descriptive information about individual objects (geographic or otherwise) and can include non-graphic, alphanumeric textual data as well as live references to image locations and web or email links. Attribute information is organized in an attribute table that associates each piece of attribute information with its corresponding object.

In one embodiment, the software tool comprises a plug-in to an authoring application, which could be a vector graphics application such as Adobe Illustrator, available from Adobe Systems Inc. of San Jose, Calif. Alternatively, the software tool can be a native component or function of the authoring application rather than a plug-in or add-on component. In either case, the software tool works seamlessly with the host application to create an interactive document directly from a new or existing source document by tagging information to objects (e.g., points, lines, and area features) on the source document. As used herein, the term “tagging” refers to the act of electronically attaching or assigning information to an object. The information tagged to objects is used to create one or more interactive effects such as pop-ups, external hyperlinks and/or e-mail links, external Javascript or VB Script links, navigation control, layer visibility control and search capabilities. When a produced interactive document is viewed through a web browser or other Flash-based delivery mechanism, a “pop-up” is what is displayed when an object on the interactive document is rolled over or selected (clicked on) by a user. The pop-up shows information (which can comprise alphanumeric text, images, hyperlinks, e-mail links, etc.) that has been tagged to the corresponding object. Pop-ups can include “callout bubbles,” which are displayed (typically but not necessarily as a balloon or box shaped figure) when an object on the interactive document is clicked on, and “rollovers,” which are displayed when a user rolls or hovers the cursor over an object. In one embodiment, an interactive document can be configured such that clicking on an object will cause all or a substantial amount of the tagged information to be displayed in a callout bubble, while hovering or rolling over the object causes a smaller portion of the tagged information (such as the title only) to be displayed as a “rollover.” The interactive effects can also include external hyperlinks and/or e-mail links. That is, an external web page or e-mail message would be launched when an object on the interactive document is rolled over or clicked on by a user.

Advanced customization of the interactive document, including features such as layer control (i.e., ability to turn layer visibility on or off), navigation controls, search capabilities, pop-up style, highlight colors, size and more, is also available. After the desired information is attached, the document is exported to Flash and the software tool automatically creates all the files necessary for viewing the interactive document through a web browser or other Flash-based delivery mechanism. The software tool allows a user to create an interactive document using basic syntax of any suitable markup or coding language, such as HTML to name one; extensive knowledge of Flash programming or specialized coding languages is not required.

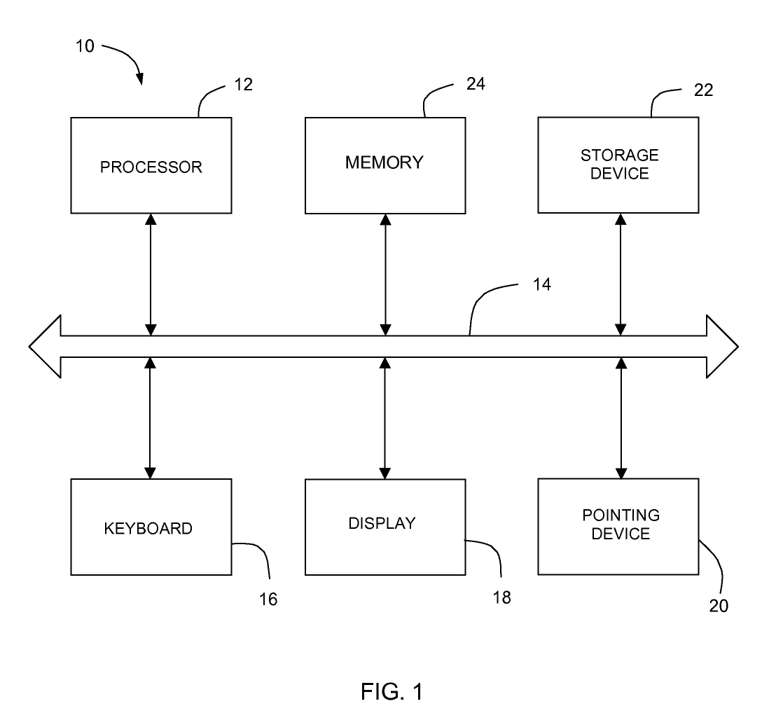

Referring now to the drawings wherein identical reference numerals denote the same elements throughout the various views, FIG. 1 shows a block diagram of an exemplary computer system 10 that can be used to implement the software tool. The computer system 10 contains a processor 12 that communicates with other elements of the computer system 10 over a system bus 14. A keyboard or similar input device 16 allows a user to input information into the computer system 10, and a display 18 allows the computer system 10 to output information to the user. A pointing device 20 is provided for moving the cursor or pointer on the display 18 and inputting information. The pointing device 20 is typically a mouse, but can also be a touch pad or a button device commonly used in laptop computers. A storage device 22 is used to store data and programs within the computer system 10. A memory 24, also attached to the system bus 14, contains an operating system.

With any implementation, the software tool can be loaded onto a non-removable computer readable medium of the computer system 10, such as the storage device 22. Alternatively, the software tool could be accessed from a removable computer readable medium (such as a floppy disk, CD-ROM, flash drive, memory card or the like) inserted into the appropriate drive of the computer system 10. The software tool could also reside on a remote computer readable medium and be accessed via the Internet or another computer network. As used herein, the term “computer readable medium” refers generally to any medium (including both volatile and non-volatile media, as well as removable and non-removable media) from which stored data can be read by a computing device. Computer readable media include, but are not limited to, hard disks, floppy disks, magnetic cassettes, flash memory cards, flash drives, optical media such as a CD-ROM, CD-R, CD-RW, DVD-ROM, DVD-RAM and the like, random access memories (RAMs), read only memories (ROMs), and other integrated circuit memory devices as well as remote drives and storage facilities accessed via a computer network or existing in a virtual space now commonly referred to as “The Cloud.” While one exemplary computer system has been described for purposes of illustration, it should be noted that the present invention is not limited to implementation on this particular system. One skilled in the art will recognize that many other systems are possible.

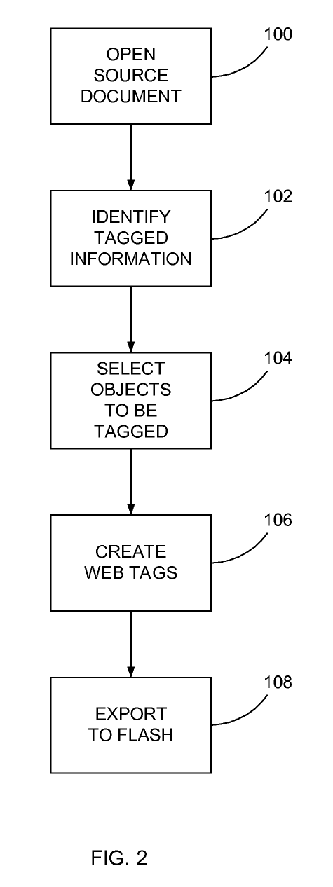

Referring to FIG. 2, one embodiment of a computer implemented method for converting a document into an interactive document using the software tool is depicted. As mentioned above, the software tool can be either a plug-in to a host application or a native component of the host application, or potentially an application unto itself. The process begins at block 100 when a source document (i.e., a document to be converted into an interactive document) is opened or created in the host software application (i.e., the application, such as a vector graphics application, with which the software tool interacts). The source document can be obtained in any manner. For instance, the source document could be a document downloaded from the Internet or another source, or the user could have created the source document using either the host software application or some other compatible software application. In some instances, such as a map document created with a vector graphics application using GIS data, the source document may already have defined objects and associated attribute information. For example, a map of the United States would typically have various objects, such as states (area objects), roads (line objects), and cities (point objects), embedded therein. As mentioned above, these objects could be organized into multiple data layers. In other instances, such as where the source document is an image, the user will need to manually define the desired objects. For example, with an image of a group picture, the user would define a polygon or area object over each person in the picture so that information about each person could be tagged to the object corresponding to the person, essentially defining the distinct interactive area(s) of the document with which the user would interact to retrieve and display the tagged information.

Next, at block 102, the information to be tagged to the source document is identified and/or collected. This information, referred to herein as “tagged information,” can comprise many forms including alphanumeric text, links to web pages, video, and images. The software tool supports image formats that are supported for web pages, such as GIF, JPEG, PNG and the like. Where the source document is a map document created with GIS data, the tagged information can comprise attribute information contained in the source document. Tagged information can also be information imported into the host application or manually input by the user using functions included in the software tool. Tagged information is organized in an attribute table that associates each piece of information with the object to which it corresponds. The attribute table is stored in a working directory on the computer system 10 so as to be accessible by the host application and software tool.

The next step is to select the objects (e.g., points, lines, and area features) on the document that are to be tagged with information, as depicted at block 104. This can be accomplished by accessing a graphical user interface (GUI) that enables the user to select the data layer containing the objects to be tagged. As mentioned above, the source document may or may not have defined objects formed therein. In instances where the source document does not contain objects that the user wants to tag, the user will need to manually define the objects prior to selecting them.

The next step, at block 106, is to create a “web tag” for each object by tagging information to objects and thereby defining the desired content of the interactive effects, such as pop-ups. This is accomplished by accessing another graphical user interface, such as a dialog box, which enables the user to tag the desired information to objects. This graphical user interface also allows the style and appearance of pop-ups to be set. The web tags can be created all at once for multiple objects by using simple HTML tags or other supported syntax in the dialog box to extract and apply information from the attribute table. This approach globally applies settings to all of the selected objects, thereby maintaining a consistent design throughout the document, and uses the unique attribute values contained in the attribute table to automatically populate the callout values for each particular object. Settings for one or more of the objects can also be individually adjusted after applying a global style to the selected objects. Alternatively, the user can manually add callout information to individual objects one at a time.

After the web tags have been created, the document is ready to be exported to Flash, as depicted at block 108. The software tool provides another graphical user interface for enabling exporting to Flash. This graphical user interface allows the user to select various settings such as export folder location, layer visibility toggle, search enabling, document dimensions, navigation options (e.g., zoom in, zoom out, panning), image quality and customization of various additional options including the colors and styles used when objects in the final document are selected or queried or indentified in a search result. Once all the settings have been set, the user initiates the export process by clicking on the appropriate button on the graphical user interface. The software tool then automatically creates a set of files (which can comprise one or more files) that defines the interactive document. This set of files is derived from the source document data file plus the user input (web tags, export settings, etc.); the software tool thus converts or transforms the source document data into the interactive data files. The resulting interactive document incorporates the subject matter of the source document and the interactive features designated by the user.

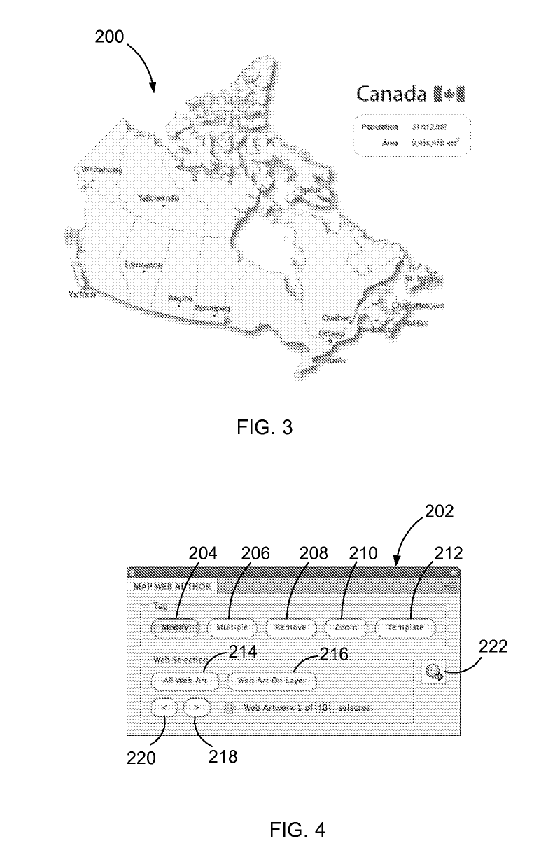

Referring now to FIGS. 3-10, one example of a source document being converted into an interactive document is illustrated. In this example, the source document 200, shown in FIG. 3, is a map of Canada created with GIS data. The map shows the thirteen Canadian provinces and territories, the capital city of each province/territory, the name of each capital city, and a background legend. These items are defined objects formed in the source document and organized into distinct data layers. Specifically, the source document 200 comprises five data layers: a layer that defines the shape and size of Canada (i.e., the international borders), a layer that defines the boundaries of the provinces and territories, a layer that defines the locations of the major cities, a layer that defines the names of the major cities, and a layer that defines the background information. The objective is to convert the source document 200 into an interactive web document in which a pop-up containing information about each province or territory is displayed when the province or territory is rolled over or clicked on by a user. (Alternatively, the document can be set up so that the entire pop-up is displayed when an object is clicked on and only the title of the pop-up is displayed when the object is hovered over or as another alternative, a URL link action can be applied). Thus, the provinces and territories are the objects on the source document that will be tagged with information. The five fields of tagged information that will be used in this example are: province/territory name, population count, provincial/territorial flag image, capital city, and official webpage hyperlink. In order for the flag images to be accessible to the software tool, the image files are stored on the computer system 10 in a source media folder created for this purpose. In this example, this source media folder is named “ImageFiles.”

To begin the process, the source document 200 is opened in the host software application. As mentioned above, the software tool interacts with the host application (as a plug-in or a native, embedded component) and causes a special toolbar or button or menu item to be displayed onscreen when the host application is open. This toolbar presents buttons, icons, menus or other input or output elements that allow a user to utilize the software tool functionality to produce interactive documents. For example, the toolbar enables a user to access the editing panel 202 shown in FIG. 4. The editing panel 202 is a starting point for utilizing the software tool.

As seen in FIG. 4, the editing panel 202 includes a tagging section comprising a Modify button 204, a Multiple button 206, a Remove button 208, a Zoom button 210, and a Template button 212. Clicking on the Modify button 204 or the Multiple button 206 opens a web tag dialog box (described in more detail below) that is used to design the content and appearance of the pop-ups. If the Modify button 204 is clicked on, the user is able to add a new web tag or modify an existing web tag for a single selected object. When several objects are selected, the Multiple button 206 is enabled, allowing the user to add or edit web tags for the several objects at once. Objects that have been tagged in the multiple mode may be modified individually at a later stage using the Modify button 204. The Remove button 208 is selected to clear the web tags for the selected objects, and the Zoom button 210 is clicked to zoom to the tagged object. The Template button 212 allows the user to create a template of default tags that is accessible from the web tag dialog box.

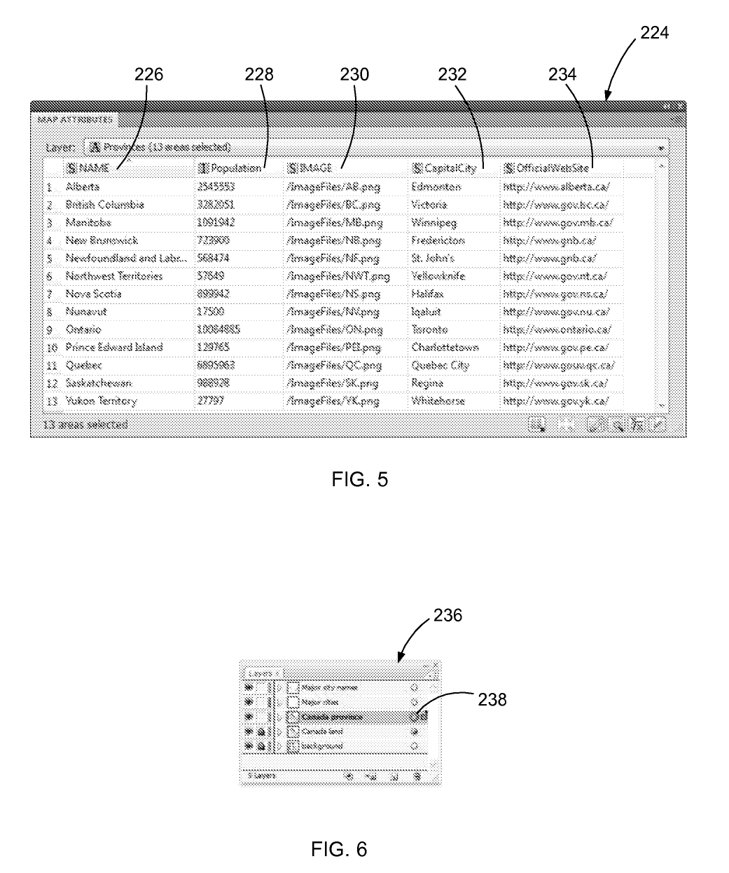

Next, the desired tagged information is assembled and organized into an attribute table 224 as shown in FIG. 5. Specifically, the attribute table 224 consists of thirteen rows, numbered 1-13, corresponding to the thirteen provinces and territories in the province/territory data layer. (There can be one such attribute table for each layer and in any event one such attribute table for each layer containing attribute data.) The attribute table 224 also has five columns corresponding to the five fields of tagged information to be included in the web tags of the interactive document. This includes a “NAME” column 226 that contains the name of each province/territory, a “Population” column 228 that contains the population of each province/territory, an “IMAGE” column 230 that contains a file path to the image of the flag for each province/territory, a “Capital City” column 232 that contains the name of the capital city of each province/territory, and a “Official Website” column 234 that contains a hyperlink to the governmental website of each province/territory. The attribute table 224 thus contains all the tagged information that may be tagged to the web tag of each province/territory and associates each piece of tagged information with the corresponding province/territory. This is likewise done for each layer of the document for which attributes are desired to be present and accessible in the final output. In this example, the province or territory name, population count, and capital city are GIS attribute information embedded in the source document and are automatically entered into the attribute table 224. The flag images and website hyperlinks may be separately imported or manually entered into the attribute table 224. Alternatively the attribute data and/or image locations and hyperlinks may be imported or combined from external data sources such as, but not limited to, Excel documents, CSV documents, databases and other such file structures in which tabular data is commonly housed.

Referring again to FIG. 4, the editing panel 202 also includes an object selecting section comprising an All Web Art button 214 and a Web Art On Layer button 216. Clicking on the All Web Art button 214 selects all the objects with web tags in the document, and clicking on the Web Art On Layer button 216 selects all the objects with web tags in the currently selected layer. Forward and backward navigation buttons 218, 220 allow the user to consecutively navigate from one web tag object to another. The editing panel 202 also has an Export to Web button 222 that opens an export dialog box (described below).

The objects to be tagged are also selected. To do this, the user either accesses a layer selection panel 236 shown in FIG. 6 using the tools provided by the host application in which the functionality of the software tool is resident as a plug-in or native component and in which the authoring is done or directly selects objects by clicking on them or making a marquee selection (in the case of selecting multiple objects at one time) using the tools provided by the host application in which the functionality of the software tool is resident as a plug-in or native component and in which the authoring is done. The user selects all the objects (i.e., the thirteen provinces and territories) in the “Canada province” layer by clicking the target symbol 238 adjacent to the Canada province layer.

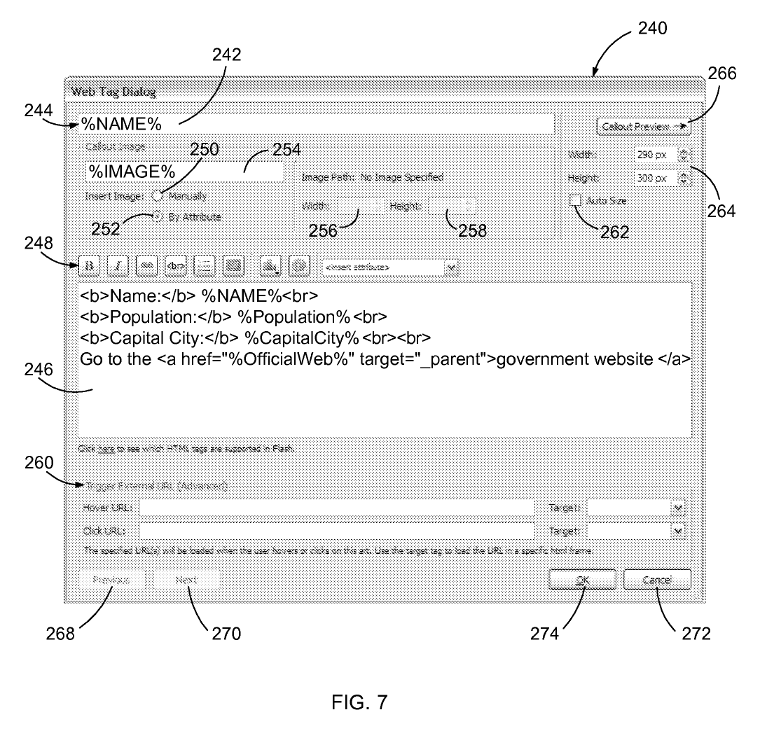

Once the objects to be tagged have been selected, the web tags are created. Because more than one object is selected, the user clicks on the Multiple button 206 to open a web tag dialog box 240, shown in FIG. 7. The web tag dialog box 240 is a graphical user interface used to design the content and appearance of the pop-ups. In the illustrated embodiment, the web tag dialog box 240 includes a Title text box 242 in which the title of the pop-up is entered, an image section 244 in which image content can be specified, and a Content text box 246 in which the desired content of the pop-up is entered. Although in this example, syntax has been employed to draw the bubble values from the attribute table uniquely for each object, static values may also be used in which case the same information will be tagged to each object.

In the web tag dialog box 240, text and image parameters are edited using simple HTML tags. (It should again be noted that while HTML tags are used in this illustrative example, the present invention is not limited to only HTML syntax). HTML tags are key codes written between a less than sign (<) and a greater than sign (>) that indicate how a web browser or other viewing environment should display the text or what action (ex. opening a certain web page) should result from a particular pointer event. The affected text is contained between an opening tag and a closing tag. Both the opening and closing tags use the same key code, but the closing tag is preceded with a forward slash sign (/), effectively bracketing the tag value. Other HTML tags are available to insert hyperlinks and images. The web tag dialog box 240 can cause text, images and hyperlinks to be extracted from the attribute table 224 and globally applied to the web tags by entering the information field name between two percent symbols (%). Accordingly, in this example, “%NAME%” is entered in the Title text box 242. Thus, the value in the NAME column of the attribute table 224 for each corresponding object will appear as the title of that object's pop-up. In other words, the title of the pop-up for Alberta will be “Alberta,” the title of the pop-up for British Columbia will be “British Columbia,” and so on.

Additional pop-up content is specified in the Content text box 246. In the illustrated example, the term “<b>Name:</b>%NAME%<br>” is entered in the first line of the Content text box 246. This means that the first line of the pop-up will read “Name:” in bold followed by the name of the corresponding province/territory taken from the attribute table 224 and then followed by a line break. The second and third lines of the pop-up will similarly show the population and capital city of the respective province/territory. The term entered in the fourth line of the Content text box 246, will cause the words “Go to the” to appear followed by the words “government website” appearing as a hyperlink to the corresponding link list in the OfficalWeb attribute field of the attribute table 224. The web tag dialog box 240 includes a series of editing tool buttons 248 that can be used to format and edit text and automatically create HTML tag formatting.

The image section 244 allows the user to insert images into the pop-up. The image section 244 includes a Manually radio button 250 and a By Attribute radio button 252. Selecting the Manually radio button 250 will allow the user to browse to the desired image file with a file navigator and add it manually. If the By Attribute radio button 252 is selected (as shown in FIG. 7), the user will enter the name of the information field that contains the image file path between percent signs (%) in an image text box 254. In the illustrated example, “%IMAGE%” is entered in the image text box 254, causing the image file path for each province/territory to be extracted from the attribute table 224 and applied to the corresponding web tag. By default, the original image size will be maintained. However, it is possible to customize the image size by using the Width and Height text boxes 256, 258. When inserting an image using the options of the image section 244, the image will be positioned at a default position in the pop-up. However, by inserting an image using the image HTML tag (<img>) in the Content text box 246, the positioning and alignment of the image in the pop-up can be adjusted.

The web tag dialog box 240 also includes a Trigger External URL section 260 that allows users to setup properties so that web pages may be opened in a targeted frame or external Javascript routines executed, when either clicking or hovering on an object of the produced interactive document.

Options for setting the size of the pop-up are provided. An Auto Size checkbox 262, which if checked, will cause the size of the pop-up to be automatically set based on the size of the image and text contents. Alternatively, the size of the pop-up or callout bubble can be set manually using Callout Size boxes 264.

The web tag dialog box 240 also includes a Callout Preview button 266. At any time while creating a pop-up, the user can click on the Callout Preview button 266 to cause a preview of the pop-up to be displayed onscreen to show how the callout bubbles or other pop-ups will look when finally published. Previous and Next buttons 268, 270 allow the user to switch from one web tag object to another when multiple objects are selected. When the pop-ups are completed, the user can click on the OK button 272 to close the web tag dialog box 240 and save the pop-up designs. Clicking on the Cancel button 274 will close the web tag dialog box 240 and cancel the pop-up designs.

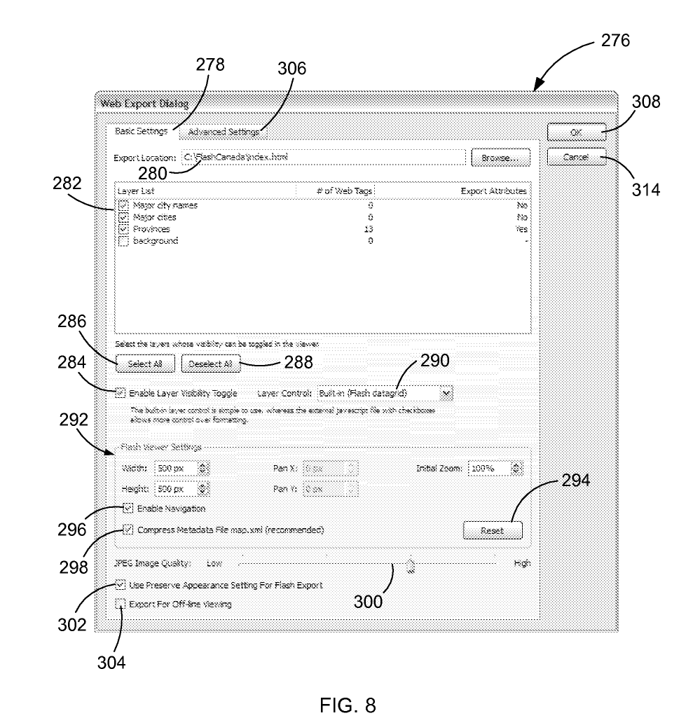

Once the pop-ups have been created, the document is exported to Flash to finish the interactive document. This is initiated by clicking on the Export to Web button 222 on the editing panel 202 to open an export dialog box 276 shown in FIG. 8. The export dialog box 276 is a graphical user interface that presents many options for entering the desired settings for exporting the document to Flash. Under the Basic Settings tab 278, the user enters the desired export folder (the location to which the completed file set will be saved) for the exported Flash document in the Export Location text box 280. The Layer List text box 282 lists all the layers in the document, the number of web tags created in each layer, and which layers have exported attributes (when used in web tags). If the user wishes the interactive document to have a layer control panel, the Enable Layer Visibility Toggle checkbox 284 is checked. Then, the checkbox adjacent to the layer names in the Layer List text box 282 is checked for each layer to be included in the layer control panel. The major city names, major cities, and provinces layers are checked in the illustrated example. Thus, it will be possible to toggle on and off display of these layers by checking the appropriate boxes in the layer control panel of the produced interactive document when opened in a web browser or other viewer. The layers that are not checked in the Layer List text box 282 are exported and visible in the interactive document, but it will not be possible to toggle them on and off of the display. When the Enable Layer Visibility Toggle checkbox 284 is checked, the Select All and Deselect All buttons 286, 288 will be enabled, allowing the user to quickly select or deselect, respectively, all of the layers in the Layer List text box 282. The style of the layer control panel is set through the Layer Control list box 290. For example, this could provide options for automatically placing layer controls on the interactive document or for placing layer controls externally and allowing the position and layout to be re-arranged using HTML tags or the like.

The Flash Viewer Settings section 292 allows Users to setup various parameters affecting how the interactive document will be displayed when opened in a web browser or other viewer. These parameters include the size (width and height) of the interactive document in the web browser or other viewer, the initial pan shift (X and Y) applied when the interactive document is opened, and the zoom level when the interactive document is initially opened. Clicking on the Reset button 294 will change the size settings back to the default settings. Also, checking the Enable Navigation checkbox 296 will cause navigations controls (e.g., pan up, pan down, pan left, pan right and zoom-in and zoom-out) to be displayed on the interactive document. Checking the Compress Metadata File checkbox 298 will cause the metadata file to be compressed during the export. The metadata file is used by the Flash viewer to get information on the initial zoom level, web tag contents (text and image paths), aspect of the pop-up and tagged object geographic coordinates. Using a compressed version of this file allows for faster loading of the interactive document on a web site. However, with an uncompressed version, an advanced user could create programs that automatically update the web tag contents.

Additional settings include the JPEG Image Quality slider 300, which allows the user to set the compression level of exported images. Checking the Preserve Appearance checkbox 302 flattens the document into a single layer before export, which may maintain quality. The Export For Off-line Viewing checkbox 304 can be checked if the exported Flash document is intended for off-line use only, not for web distribution.

Under the Advanced Settings tab 306, the user can make more detailed changes to the default display settings, such as positioning of the pop-up, the appearance settings for the pop-ups, options for pop-up behavior, color and thickness of lines marking clicked and hovered over objects, the zoom and pan factors of the navigation controls. The user is also able to enable the display of a search box on the interactive document, as well as set the styles for the search box and the highlighting of objects found in a search. Choosing this option makes the produced interactive document searchable.

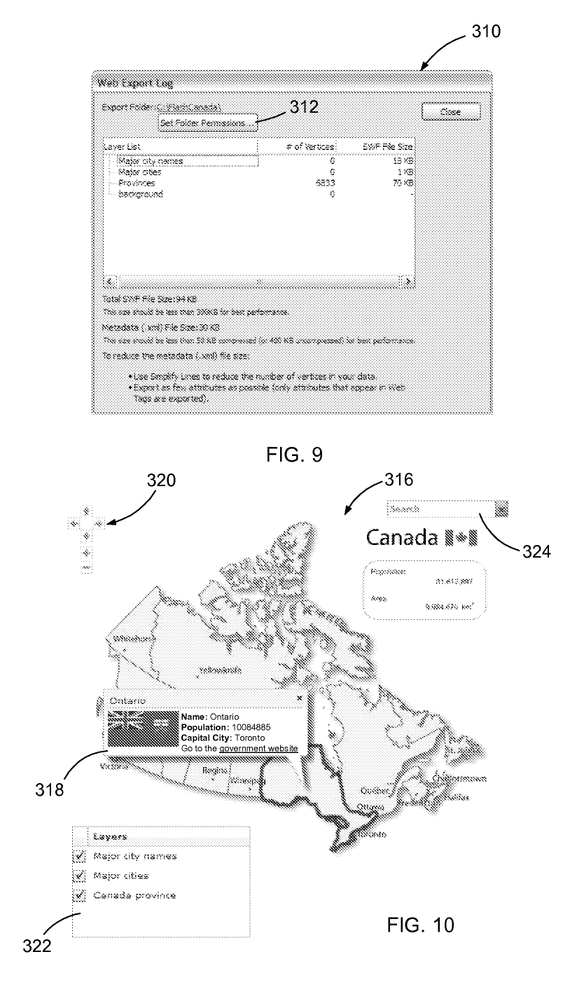

Once all the desired export settings have been entered in the export dialog box 276, the user clicks the OK button 308 to launch the export to Flash. The software tool creates a set of default files together with the files specific to the interactive document. These files, plus all other components required for the interactive document, are stored in the export folder (designated in the Export Location text box 280). In addition, an export summary is displayed in a web export log 310, shown in FIG. 9. The web export log 310 includes a Set Folder Permissions button 312. Clicking this button 312 allows the user to set permissions with the export folder so that the interactive document can be viewed with a web browser or other viewer. The web export log 310 also displays information on the file size to warn the user of very large files, which may be slow to open on a web site. If the user decides not to export the document, clicking on the Cancel button 314 will close the export dialog box 276 and cancel any settings that had been made.

FIG. 10 shows the final interactive document 316 for this example. The interactive document 316 includes the subject matter of the source document 200 (i.e., a map of Canada showing the thirteen Canadian provinces and territories, the capital city of each province/territory, the name of each capital city, and a background legend) plus additional interactive material. The additional material includes the pop-ups that are displayed when a tagged object (a province or territory) on the interactive document 316 is hovered over or clicked on. In FIG. 10, Ontario has been clicked on causing the outline of Ontario on the interactive document 316 to be highlighted and the pop-up or callout bubble 318 for Ontario to be displayed. The callout bubble 318 includes the title, an image of the provincial flag, province name, population, capital city and a hyperlink to the official webpage of the province.

The interactive document 316 also has navigation controls 320, which comprise a series of buttons for allowing the user to pan up, pan down, pan left, pan right and zoom-in and zoom-out). A layer control panel 322 is displayed and allows the user to toggle on and off display of the Major city names, Major cities, and Canada province layers (these were the layers checked in the Layer List text box 282 of the export dialog box 276). In other words, all of these layers are displayed in the interactive document 316 of FIG. 10 because each is checked in the layer control panel 322, but if the user were to uncheck the Major city names layer in the layer control panel 322, for example, then the major city names (Whitehorse, Yellowknife, etc.) would no longer be displayed on the interactive document 316. A search box 324 is also displayed on the interactive document 316. The user is able to search for terms in the tagged information by entering search queries in the search box 324.

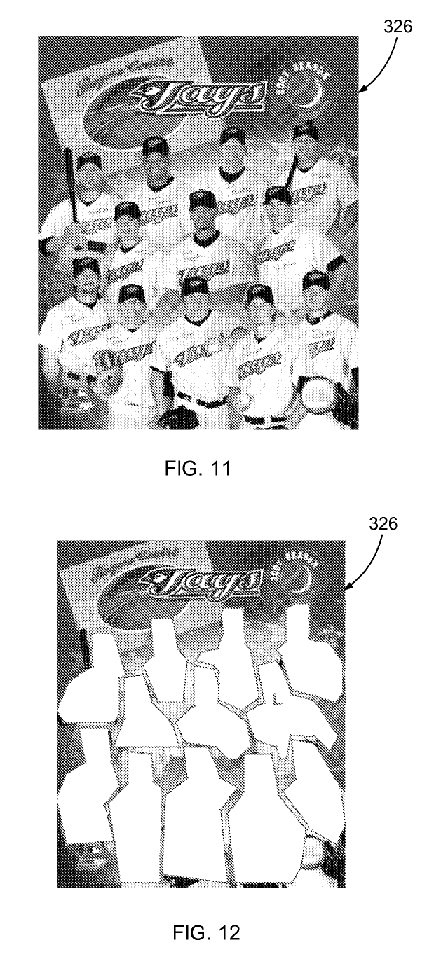

Referring now to FIGS. 11-17, an example of a non-cartographic source document being converted into an interactive document is illustrated. In this example, the source document 326, shown in FIG. 11, is a photographic image of a baseball team that has been downloaded from a web page or opened from another source and placed in the file of the host application, which in this example is an authoring application such as Adobe Illustrator. The objective for this example is to convert the source document 326 into an interactive web document in which a pop-up containing information about each player in the picture is displayed when the player's image in the picture is rolled over or clicked on by a user and to enable searching.

The process begins by opening the source document 326 in the host software application. Because the source document 326 is a photographic image, there is no GIS data or other attribute information present and there are no defined objects formed in the source document, as was the case with the Canadian map example above. Accordingly, the next step is to define the objects (which in this case are the individual players in the picture) by using the host application's native drawing functionality (or in the case of this invention being embodied as a stand-alone application or embedded component of a larger application, using the drawing tools applicable to the case) to create a distinct area over every player, as shown in FIG. 12, to define boundaries of clickable or interactive areas of the document for each player. Using the basic drawing tools of the host application (or in the case of this invention being embodied as a stand-alone application or embedded component of a larger application, using the drawing tools applicable to the case), the user would draw a suitable shape over each player to define the interactive area for that player. These shapes can be normal geometric circles, squares or any non-uniform polygonal shape as the user may desire to specifically define each area as precisely as may be wished. Once they have been created, the player objects are selected for tagging.

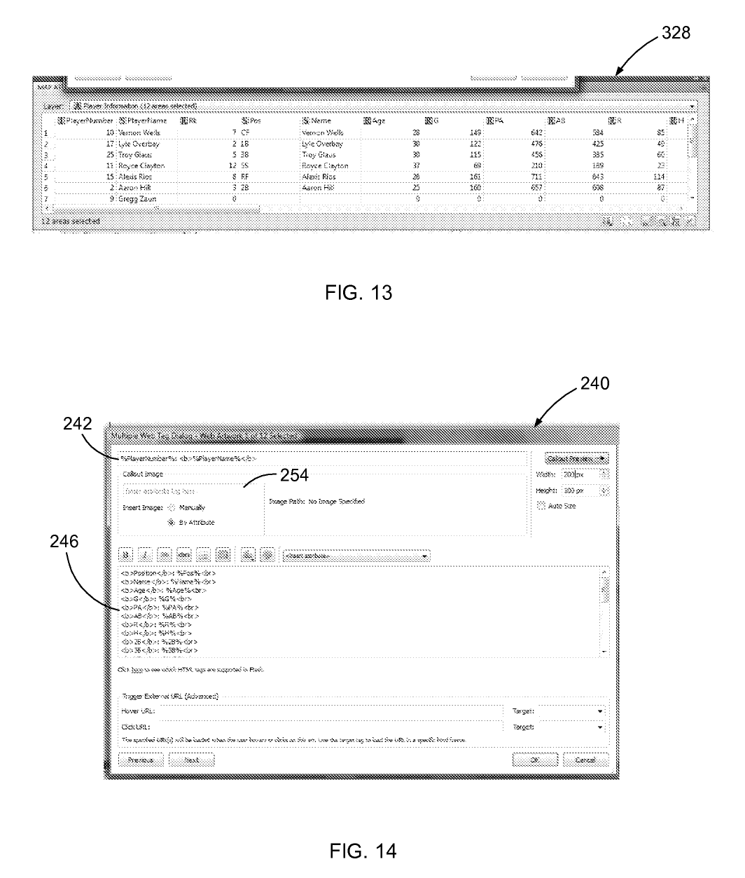

The tagged information relating to the corresponding player is assembled and organized into an attribute table 328, as shown in FIG. 13. The tagged information in this example can include individual player information such as uniform number, the player's name, position, and age, as well as the player's statistics such as games played, plate appearances, at bats, runs scored, etc. This information can be separately imported from an external data source such as a spreadsheet document or database or any other place in which information of this nature may be stored or manually entered into the attribute table 328. The attribute table 328 will contain all the information that will be tagged to the callout bubble or rollover or searchable attributes of each player and associates each piece of tagged information with the corresponding player.

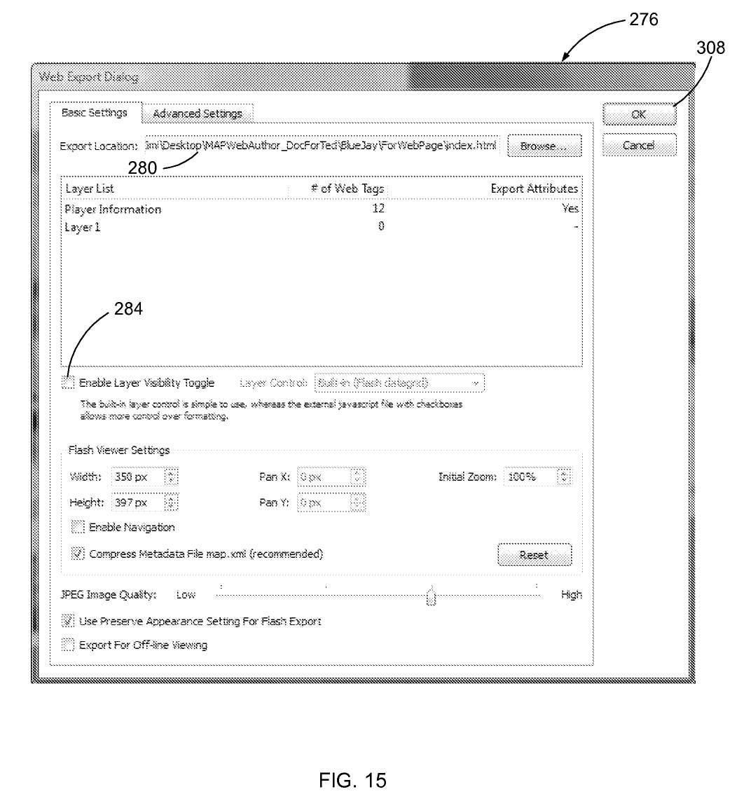

The next step is to create the web tags and thereby define the contents and formatting for the pop-ups. As was the case with the previous example, this is done by clicking the Multiple button 206 on the editing panel 202 to open the web tag dialog box 240. In the web tag dialog box 240, “%PlayerNumber%:<b>%PlayerName%</b>” is entered in the Title text box 242, as shown in FIG. 14. Thus, the title that will appear in the pop-ups will be the player's number, followed by a colon and then the player's name in bold. For instance, the title for Vernon Wells' pop-up will be “10: Vernon Wells.” The desired pop-up content (position, name, age, games played, etc.) is specified in the Content text box 246 using HTML tags, in a manner similar to that described above in the previous example. No images are used in the pop-ups for this example, so the image text box 254 is left empty.

Before exporting the document to Flash, the host application's functionality can be used to change the color properties for the interactive areas over the players in the picture to “no fill color” and “no stroke color.” Accordingly, the interactive areas do not obscure the player images and are essentially invisible to the reader or viewer except when accessed, selected or displayed as the result of a search. The document is now exported to Flash by first clicking on the Export to Web button 222 on the editing panel 202 to open the export dialog box 276 shown in FIG. 15. The user enters the desired export folder for the exported Flash document in the Export Location text box 280. Because the document does not comprise multiple layers of visible data, there is no need for layer control, and the Enable Layer Visibility Toggle checkbox 284 is thus unchecked. The remaining export settings are entered as desired. The user then clicks the OK button 308 to launch the export to Flash.

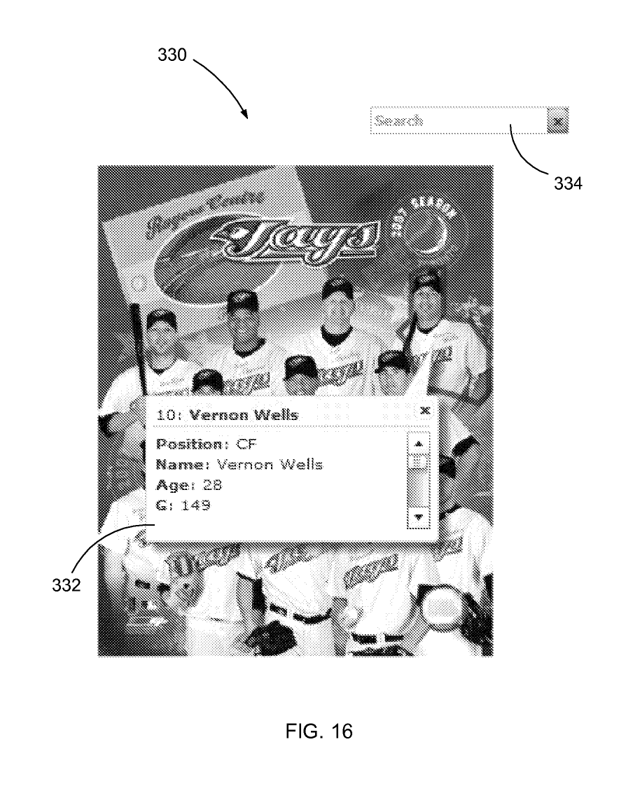

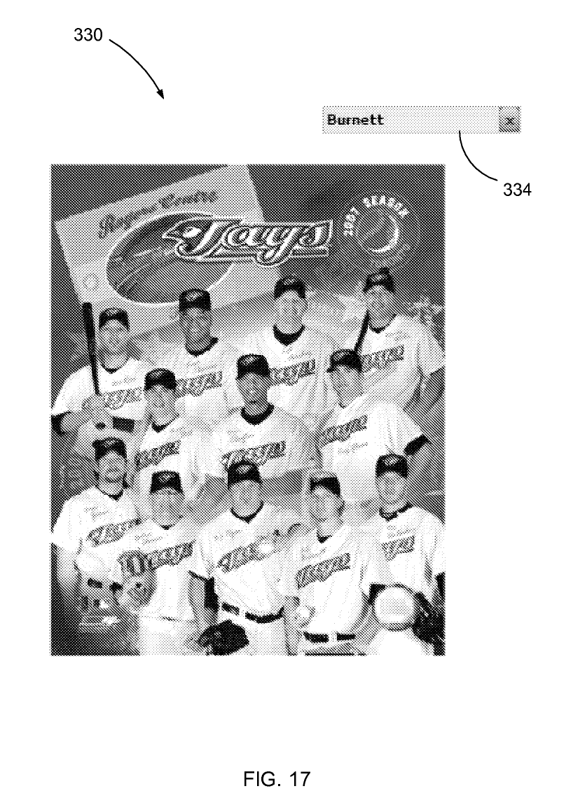

FIG. 16 shows the final interactive document 330 for this example. The interactive document 330 includes the team picture of the source document 326 plus interactive pop-ups that are displayed when a tagged object (a player) on the interactive document 330 is hovered over or clicked on. In FIG. 16, player Vernon Wells has been clicked on causing the area surrounding Vernon Wells to be highlighted and the callout bubble 332 for Vernon Wells to be displayed. In this example, the callout bubble 332 has a scroll bar because the amount of player information tagged to the callout bubble exceeds the size of the bubble. The interactive document 330 also has a search box 334 that allows searching of the callout information. For example, the user could enter a player's name in the search box 334, and then that player would be highlighted on the interactive document 330, as shown in FIG. 17.

While specific embodiments of the present invention have been described, it should be noted that various modifications thereto can be made without departing from the spirit and scope of the invention as defined in the appended claims.

What is claimed is:

1. A computer-implemented method for converting a source document having graphical subject matter into an interactive document, said method comprising:
receiving, via a user interface, input regarding information to be tagged to objects on said source document;
tagging information to objects on said source document in response to said received input to create one or more interactive effects based on said tagged information; and
automatically creating a set of files that defines an interactive document, wherein said interactive document incorporates said subject matter of said source document and includes said interactive effects.

2. The method of claim 1 wherein creating said one or more interactive effects includes creating one or more pop-ups containing said tagged information.

3. The method of claim 2 further comprising setting the style and appearance of said pop-ups in response to input received from said user interface.

4. The method of claim 1 wherein creating said one or more interactive effects includes an external hyperlinking action.

5. The method of claim 1 wherein creating said one or more interactive effects includes an external e-mail linking action.

6. The method of claim 1 wherein creating said one or more interactive effects includes an external Javascript or VB Script linking action.

7. The method of claim 1 further comprising:
organizing information to be tagged in an attribute table that associates each piece of said information with the object to which it corresponds; and
extracting information from said attribute table when tagging said information to objects on said source document

8. The method of claim 1 further comprising receiving, via a user interface, input regarding settings for automatically creating said set of files that defines an interactive document.

9. The method of claim 1 further comprising:
receiving, via a user interface, input regarding providing said interactive document with navigation controls; and including navigation controls in said interactive document.

10. The method of claim 1 further comprising:
receiving, via a user interface, input regarding providing said layer control; and including layer control in said interactive document.

11. The method of claim 1 further comprising:
receiving, via a user interface, input regarding providing said interactive document with searching capability; and including searching capability in said interactive document.

12. The method of claim 1 wherein said source document has defined objects.

13. The method of claim 1 further comprising defining objects on said source document.

14. A computer readable medium containing instructions for controlling a computer system to perform a method for converting a source document having graphical subject matter into an interactive document, wherein said method comprises:
receiving, via a user interface, input regarding information to be tagged to objects on said source document;
tagging information to objects on said source document in response to said received input to create one or more interactive effects based on said tagged information; and
automatically creating a set of files that defines an interactive document, wherein said interactive document incorporates said subject matter of said source document and includes said interactive effects.

15. The computer readable medium of claim 14 wherein creating said one or more interactive effects includes creating one or more pop-ups containing said tagged information.

16. The computer readable medium of claim 15 further comprising setting the style and appearance of said pop-ups in response to input received from said user interface.

17. The computer readable medium of claim 14 wherein creating said one or more interactive effects includes an external hyperlinking action.

18. The computer readable medium of claim 14 wherein creating said one or more interactive effects includes an external e-mail linking action.

19. The computer readable medium of claim 14 wherein creating said one or more interactive effects includes an external Javascript or VB Script linking action.

20. The computer readable medium of claim 14 further comprising:
organizing information to be tagged in an attribute table that associates each piece of said information with the object to which it corresponds; and
extracting information from said attribute table when tagging said information to objects on said source document

21. The computer readable medium of claim 14 further comprising receiving, via a user interface, input regarding settings for automatically creating said set of files that defines an interactive document.

22. The computer readable medium of claim 14 further comprising:
receiving, via a user interface, input regarding providing said interactive document with navigation controls; and
including navigation controls in said interactive document.

23. The computer readable medium of claim 14 further comprising:
receiving, via a user interface, input regarding providing said layer control; and
including layer control in said interactive document.

24. The computer readable medium of claim 14 further comprising:
receiving, via a user interface, input regarding providing said interactive document with searching capability; and
including searching capability in said interactive document.

25. The computer readable medium of claim 14 wherein said source document has defined objects.

26. The computer readable medium of claim 14 further comprising defining objects on said source document.
